(19) United States
(12) Patent Application Publication
(10) Pub. No.: US 2004/0242308 A1
(43) Pub. Date: Dec. 2, 2004

(54) Games of chance using a cash till roll

(76) Inventor: Andrew P Gray, Halifax (GB)

Correspondence Address: KENYON & KENYON, ONE BROADWAY, NEW YORK, NY, 10004, US

(21) Appl. No.: 10/477,857

(22) PCT Filed: May 11, 2001
(86) PCT No.: PCT/IB01/01215

(51) Int. Cl. A63F 13/00

(52) U.S. Cl. 463/17

(57) ABSTRACT

Several embodiments of promotional games of chance played using game tickets, having one or more playing game pieces, that are pre-printed on the reverse side of a cash register till roll and a method of and system for playing the promotional game are disclosed. The promotional game tickets may be distributed at a point of sale terminal, e.g., sales register, at or during the normal course of a sales transaction at which at least one item is purchased. Furthermore, the odds of winning one or more prizes may be improved as the number of items purchased as part of the sales transaction increases. The promotional games may include an instant lottery-type format, a draw-type lottery format, an interactive game format, or a combination of any and all of these formats.

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND INFORMATION

Many nations worldwide have legalized public and private lotteries and other game of chance. Furthermore, commercial enterprises recognize the value of private lottery-type promotional games of soliciting new customers and fostering customer loyalty to encourage customers to continue shopping at the enterprise's commercial establishment. Indeed, promotional games and the prizes awarded for winning entertain and stimulate the interest of customers.

Typically, these lotteries and/or games of chance (hereinafter collectively “lotteries”) include innumerable variations in two basic formats, e.g., an instant-type and a draw-type lottery. An instant lottery gets its name from the fact that determination of winning can be done virtually instantly. A draw-type lottery, on the other hand, requires the occurrence of another event, e.g., a scheduled drawing, to determine whether and which, if any, players have won.

Indeed, instant lottery games typically are played using a “scratch card”, e.g., a disposable substrate, which participants rub or scratch to remove a removable coating that conceals one or more playing game pieces and related cash prize amounts. Game participants purchase instant lottery tickets for a few dollars, e.g., $1 to $10, at point of sale terminals, which frequently are located in grocery stores, convenience stores, smoke shops, and elsewhere. Generally, instant lottery tickets are printed on heavy paper or cardboard and dispensed from rolls, which are perforated at the juncture between adjacent tickets.

Instant lottery tickets include one or more playing game pieces, which, for example, can include Arabic numerals, symbols, and/or selected playing cards, and related cash prize amounts. The playing game pieces and related cash prize amounts are pre-printed on the surface of the game ticket but are concealed from view by a removable covering until the covering is removed by a player. Accordingly, whether a lottery ticket is a winner and the prize are pre-determined. Moreover, although any number of game participants may win, there may only be one winner per scratch card.

Instant lottery play requires participants to scratch, or rub off, the removable covering, e.g., using a coin or fingernail, to reveal the underlying playing game pieces and related prize. One example of a commonly found instant lottery game is a version of “blackjack” or “twenty-one”, wherein participants scratch off one or more “house” game pieces as well as their playing game pieces. Participants win if one or more of their playing game pieces exceeds the associated “house” game pieces. When this occurs, participants win the related prize, which may be several thousands of dollars, but, more often than not, is just a few dollars.

Some commercial establishments provide their customers with a scratch ticket at check-out for which prizes, generally, store products, are awarded. Related patents to Bachman, et al. (U.S. Pat. Nos. 4,671,512 and 4,817,949) describe, respectively, an automated teller machine (“ATM”) transaction receipt bearing instant lottery-type game indicia on the reverse side of the receipt and a system for playing an instant lottery-type game that includes a transaction receipt and an ATM, respectively. According to the Bachman patents, game indicia are imprinted on a portion of the reverse side and then coated first with a translucent release coating and then with an opaque, removable masking.

Problems associated with instant lottery games including check-out scratch tickets, in general, include the cost of printing, distributing, and verifying the lottery tickets and the clutter that discarded lottery tickets make. Indeed, one of the significant costs associated with instant lottery game promotion is the cost of printing and distributing playing game tickets. Problems associated with the Bachman, et al. invention include the added cost of manufacturing the stock paper with a release coating and a removable masking.

In contrast, lottery-type games are played by selecting a pre-determined number of playing game pieces, e.g., integers, from a population of game pieces that must match all or substantially all of the winning game pieces drawn randomly during a schedule drawing event. Game participants purchase lottery tickets for a few dollars at point of sale terminals, which again can be located in grocery stores, convenience stores, smoke shops, and elsewhere. Generally, lottery tickets are dispensed from a printer that communicates with an on-line server. In this manner, the on-line server may (i) maintain a database of all game ticket combinations; (ii) determine immediately whether there has been one or more winners; and (iii) produce a “quick pick” ticket of playing game pieces selected at random from the population of game pieces for those participants who do not want to select playing game pieces themselves.

There are several versions of lottery-type games. One version requires participants to select both the game pieces and the sequence in which the game pieces will be drawn. For example, a common “Pick Four” game requires game participants to select four numbers, which typically include integers from 0 to 9 with replacement, and the sequence in which these numbers will be drawn. Hence, for example, if a participant selects 1-2-3-4, he or she would win if and only if the winning numbers 1, 2, 3, and 4 are drawn in the proper sequence. Participants do not win if the winning numbers are drawn in a different sequence, e.g., 2-3-4-1 or if different numbers are selected altogether, e.g., 1-2-3-5.

A second version of a lottery-type game, e.g., “Lotto”, basically is played in the same manner, e.g., by selecting a pre-determined number of playing game pieces, e.g., integers, and then matching all or slightly less than all of the winning game pieces, which, for example, typically are selected randomly during a scheduled drawing event. This version differs from the previous “Pick Four” version in that (i) drawing sequence is not important; (ii) the population of playing game pieces typically is much larger, e.g., integers from 1 to 49; (iii) there is no replacement; and (iv), typically, participants must select more playing game pieces.

It is important to note that in this version of the lottery-type game, the number of playing game pieces selected is the same as the number of winning game pieces drawn. The odds of winning the game decrease significantly as the number of game pieces comprising the combination of winning game pieces increases. As a result, typically, only a relatively small number of game participants win any prize. Accordingly, prizes, e.g., cash jackpots, usually are quite large.

A third version of the lottery-type game is commonly known as “keno”, which is a hybrid of the second version described above. Indeed, keno basically is played in the same manner, e.g., by selecting a number of playing game pieces selected during a scheduled drawing event. “Keno” games differ from “Lotto” games in that (i) the population of playing game pieces is larger still, e.g., integers from 1 to 80; (ii) participants may choose the number of game pieces that they want to match; and (iii) the number of winning game pieces drawn, e.g., twenty (20), is larger than the number of a participant's playing game pieces, e.g., two (2) to ten (10).

Accordingly, the odds of winning at “keno” are better than “Lotto” but prizes, e.g., cash jackpots, are usually smaller. Moreover, “keno” is much less linear than “Lotto”, which is to say that one's chances of winning do not end when the first winning game pieces drawn does not match any of the participant's playing game pieces. Accordingly, more participants may win some prize.

Draw-type lottery games, in all of their many variations, however, suffer from similar printing and distribution problems as do instant lottery games.

### BRIEF DESCRIPTION OF THE DRAWINGS

For all further understanding of the nature and desired objects of the present invention, reference is made to the following detailed description taken in conjunction with the accompanying figures wherein like reference character denote corresponding parts throughout the several views and wherein:

FIG. 1 illustrates a system for playing a promotional game of chance, according to an example embodiment of the present invention;

FIG. 2a illustrates an example cash register sales receipt, according to an example embodiment of the present invention;

FIG. 2b illustrates an example of a reverse side of a cash register sales receipt bearing a number of promotional game tickets, according to an example embodiment of the present invention;

FIG. 3 illustrates an example of a point of sale terminal, according to an example embodiment of the present invention;

FIG. 4a illustrates an example of an instant lottery-type promotional game, according to an example embodiment of the present invention;

FIG. 4b illustrates a second example of an instant lottery-type promotional game, according to an example embodiment of the present invention;

FIG. 4c illustrates a third example of an instant lottery-type promotional game, according to an example embodiment of the present invention;

FIG. 4d illustrates a fourth example of an instant lottery-type promotional game, according to an example embodiment of the present invention;

FIG. 4e illustrates an example of a draw-type lottery promotional game, according to an example embodiment of the present invention;

FIG. 4f illustrates an example of a promotional interactive, online game, according to an example embodiment of the present invention.

### DETAILED DESCRIPTION OF THE INVENTION

Accordingly, it would be desirable to produce promotional games of chance and a method of and system for playing the games that provide advantages not found in the prior art.

Example embodiments of the present invention include promotional games of chance and a method of and system for playing the games that reduce the additional expense of printing and distributing game tickets.

Example embodiments of the present invention further include promotional games of chance and a method of and system for playing the games that are readily verifiable.

Example embodiments of the present invention further include promotional games of chance and a method of and system for playing the games that follow an instant lottery-type format, a draw lottery-type format, an interactive, online-game type or a combination of these formats.

Additionally, example embodiments of the present invention further include promotional games of chance and a method of and system for playing the games, wherein participants are motivated to spend more money at the point of sale commercial establishment in order to receive a longer sales receipt and, therefore, more promotional game tickets.

These and further example embodiments are obtained by promotional games of chance and a method of and system for playing the game wherein the game is played using a reverse side of a cash register till roll as a playing game substrate, said playing game substrate comprising one or more playing game pieces disposed thereon, wherein said playing game pieces determine the outcome of the game when compared to one or more winning game pieces.

Furthermore, example embodiments of the present invention include a method of playing a promotional game, the method including: providing participants with a playing game substrate, said substrate comprising one or more playing game pieces that are disposed on a reverse side of a cash register till roll, determining whether the playing game substrate is a winning game substrate; and verifying that said playing game substrate is a winning game substrate.

Moreover, example embodiments of the present invention include a system for playing a promotional game of chance, wherein the system comprises: one or more playing game substrates, which are disposed on the reverse side of a cash register till roll; a mechanism for distributing the playing game substrates; a mechanism for determining whether a playing game substrate is a winning game substrate; and a mechanism for verifying a winning game substrate.

Example embodiments of the present invention include promotional games of chance and a method of and system for playing the games that reduce additional expenses associated with printing and distributing game substrates, e.g. tickets, to participants. Game tickets are distributed to customers by one or more commercial enterprises during normal business transactions, e.g., sales, with each commercial establishment hosting its own promotional game or games. Accordingly, the promotional games may foster customer loyalty, improve customer relations; and spark or otherwise motivate an increase in customer spending in the hosting commercial establishments.

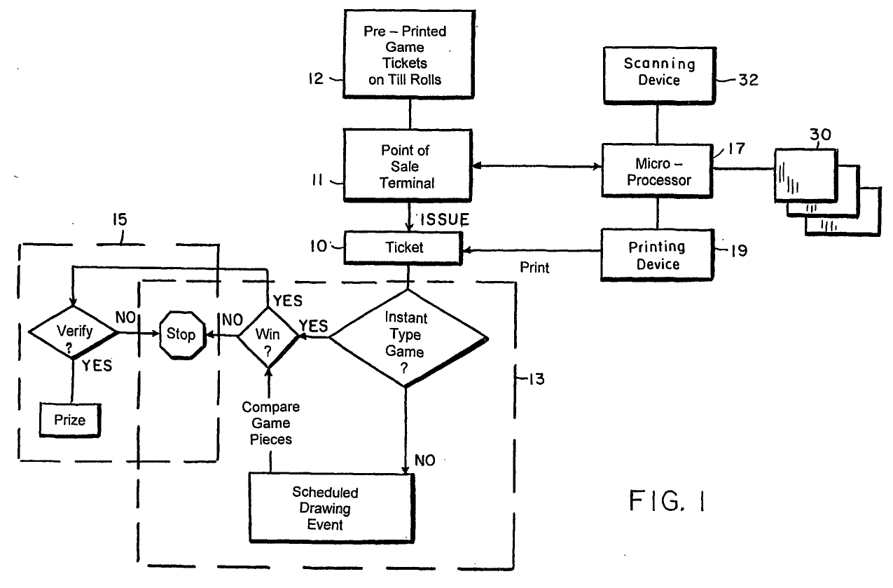

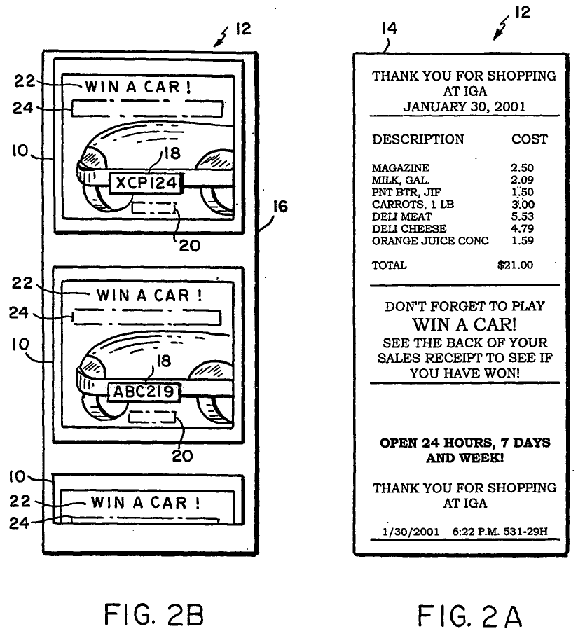

FIGS. 1, 2a, and 2b illustrate an example system for playing a promotional game. The system may include one or more promotional game tickets 10, which are pre-printed on the back, or reverse side 16, of a cash register till roll 12; a device for distributing the game tickets 10 to participants, e.g., a point of sale terminal 11, cashier's register or till box; an outcome-determining mechanism 13 for determining whether the promotional game ticket is a winning game ticket; and a verifying mechanism 15 for verifying that a promotional game ticket is a winning game ticket.

Cash register till rolls 12 (hereinafter “till rolls”) are used extensively by most commercial establishments to provide customers with a tangible record of items purchased, e.g., a sales receipt. Till rolls 12 have an obverse (front) side 14 and a reverse (back) side 16. In most instances, the reverse side 16 of a till roll 12 is blank. However, some commercial enterprises have included advertising on the reverse side 16. The obverse side 14 of the till roll 12 is used commonly to record the commercial transaction.

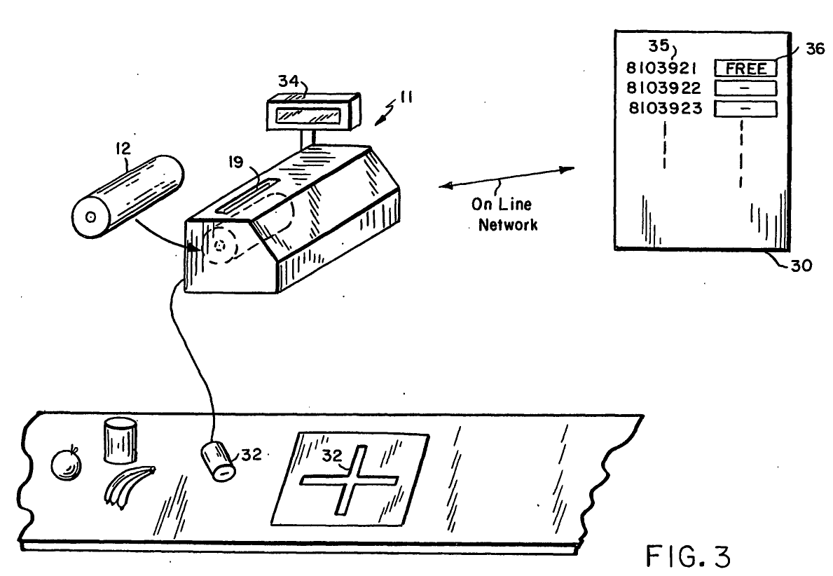

For distribution, the point of sale terminal 11 may typically include a printing device 19 that communicates with one or more scanning devices 32 through a micro-processor 17. See FIGS. 1 and 3. As items to be purchased are scanned, the scanning device 32, e.g., a laser bar code reader, transmits, and logic in the micro-processor 17 converts the item's data codes, e.g., UPC bar codes, to a binary code. Additionally, the micro-processor 17 logic accesses, e.g., “reads”, the contents, e.g., item description and unit price data, that are stored in a unique memory address 35 that corresponds to the scanned UPC data code. The address contents 36 are transmitted to the printing device 19, which prints, e.g., a description and unit price of all of the purchased items on the obverse side 14 of the till roll 12. When the last item to be purchased is scanned, the micro-processor 17 performs a summing, totaling or adding operation and further prompts the printing device 19 to print the total amount of the commercial transaction on the sales receipt 14.

The sales transaction information on the obverse side 14 of the till roll 12 is used further to partially authenticate the game ticket 10. Indeed, it is possible that no game ticket 10 may win unless a dated, printed record of at least one sales transaction appears on the obverse side 14 of the till roll 12.

According to an example embodiment of the present invention, one or more promotional game tickets 10 may be pre-printed on the reverse side 16 of the till roll 12. Although promotional game tickets 10 maybe printed to cover substantially the entire reverse side 16 of the till roll 12, there maybe as few as one game ticket printed on the reverse side 16. Alternatively, promotional game tickets 10 may be printed randomly or intermittently on the reverse side 16 of the till roll 12 without departing from the scope and spirit of the present invention.

The size of each game ticket 10, e.g., the length, may advantageously be chosen to be no greater than the standard length of a sales receipt issued for the purchase of a single item in a particular commercial establishment, e.g., about 1½ to 3 inches or about 64 to 77 mm. Accordingly, when a customer purchases one or more items for sale in a commercial establishment, he or she receives at least one promotional game ticket 10. The more items that a customer purchases, the longer his or her sales receipt will be. Hence, customers who purchase a large number of items from the commercial establishment potentially will have more opportunities to win a prize awarded for one or more of the embodied games described below.

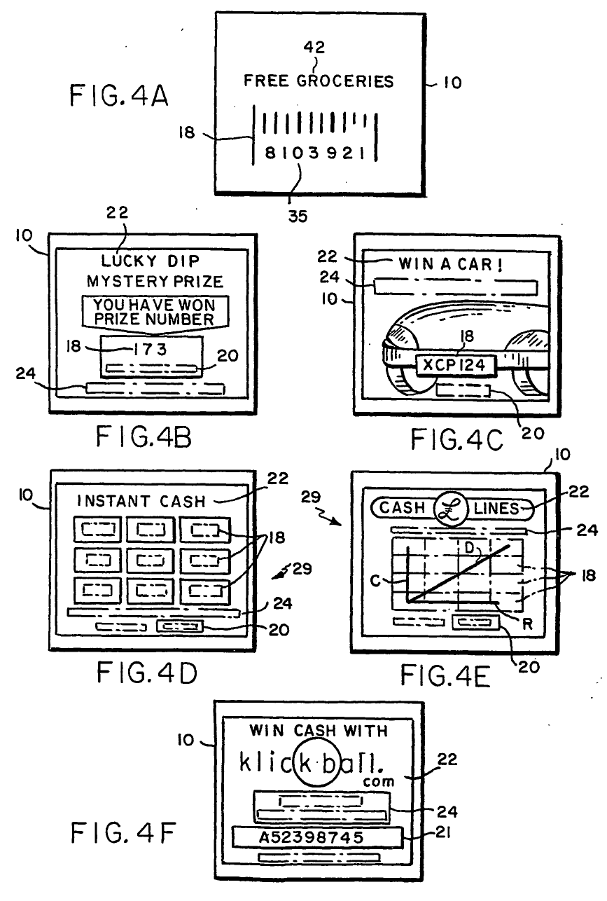

As seen in FIGS. 4a-4f, game tickets 10 may be pre-printed to include one or more of the following: a plurality of playing game pieces 18, a security code 20, an access code 21, a promotional game name 22, and instructions 24 on how to play the game and/or claim a prize. Playing game pieces 18 may include, for example, one or more of the following: Arabic numerals, dollar or cash amounts, letters from the alphabet, a word, words or phrase, selected playing cards, mah jongg tiles or a machine readable data code 35, e.g., a barcode. It should be noted, though that these exemplary playing game pieces 18 are not intended to be limiting, but rather merely to illustrate some of the possible symbols that may be used as playing game pieces 18.

The security code 20 may be used to verify whether the game ticket 10 is a wining game ticket. Alternatively, the access code 21 may be used to allow participants to access and play an online game. The security code 20 and/or access code 21 may include, for example, one or more of the following: Arabic numerals, letters from the alphabet, or a machine readable data code, e.g., a barcode. Here again, these exemplary security codes 20 and/or access codes 21 are not intended to be limiting, but rather merely to illustrate some of the possible symbols that may be used as security codes 20 and/or access codes 21.

The device for distributing promotional game tickets 10 may include distribution at the point of sale terminal 11 at the completion of or during a normal sales transaction. Point of sale terminals 11 and production of a sales receipt therewith are well known to those skilled in the pertinent art. Indeed, as items to be purchased are scanned, the printing device 19 that may be integral to and in communication with the cash register may automatically produce and maintain a running list of the description and unit price of items to be purchased on the obverse (front) side 14 of the till roll 12. As a sales record is produced, the till roll 12 advances with each additional time.

The outcome-determining mechanism 13 for determining whether a promotional game ticket 10 is a winning game ticket may include at least one of the following: a word, words or phrase and/or machine readable data coded message, an interactive, e.g., toll free, telephone site, and/or an interactive, online, e.g., Internet, Web site for instant lottery-type promotional games and/or posted or published winning numbers or a scheduled drawing event for draw-type promotional game embodiments. These outcome-determining mechanisms 13 are described in greater detail below during the description of the various game embodiments.

Similarly, the verifying mechanism 15 for verifying whether the game ticket 10 is a winning game ticket may include a visual inspection and comparing a pre-printed security code 20, which appears on the game ticket 10, with the contents 36 of one or more local or remote databases 30, in which winning security codes are stored. Alternatively, security code 20 may be compared with data contained in one or more databases 30, which databases 30 are accessible, e.g., through a network or online. These databases 30 may be accessible online, e.g., via the Internet.

The verifying databases 30 may include one or more listings of winning security codes 20 that are cross-indexed to the memory address 35a containing a prize. For example, when a customer has determined that he or she owns a winning game ticket, he or she is instructed to return the winning game ticket to the commercial establishment from whence it was purchased or to an affiliated commercial establishment. A sales person then may visually inspect the promotional game ticket 10 to ensure that it has not been tampered with and to verify that the security code 20 on the promotional game ticket 10 corresponds to a winning security code contained in one or more of the databases 30.

Having described the system for playing the promotional games of chance, several game embodiments and the methods of playing each embodied game will now be described. Common to each game embodiment may be a step in which sales personnel of a commercial enterprise distribute at least one promotional game ticket 10, which are pre-printed on the reverse side 16 of the till roll 12, to every customer who purchases at least one item from the commercial enterprise. While one includes customers purchasing items from the commercial establishment, in a separate embodiment, customers simply may request a promotional game ticket 10 at the point of sale terminal 11 without any other purchase necessary.

Several example embodiments of instant lottery-type promotional games will now be described by referring to FIGS. 4a through 4d. It should be noted, however, that the embodied instant lottery-type games are meant to be exemplary and not limiting. Indeed, those skilled in the pertinent art may apply the teachings of the present invention to innumerable instant-type games.

In a first embodiment, promotional game tickets 10 include playing game piece 18 comprising a machine readable data code 35 such as a barcode, e.g., the memory address 35a, that may be read, e.g., scanned, by scanning devices 32, e.g., barcode scanners, that are in communication with the point of sale terminal 11 through the micro-processor 17. See FIGS. 3 and 4a. Accordingly, at check-out and after the last item to be purchased has been scanned, sales personnel scan the machine readable data codes 35, e.g., the playing game pieces 18, of each of the participant's promotional game tickets 10, to determine instantly whether the one or more promotional game tickets 10 are winning game tickets. Sales personnel may scan the one or more playing game pieces 18 on the reverse side 16 of the till roll 12 before the sales receipt has been removed, e.g., torn from the cash register 11, and, possibly, before the customer has paid for the items purchased.

The machine readable data code 35, for example, may include the unique memory address 35a in a database 30. Micro-processor 17 logic converts the data code 35 to a binary code, which further identifies the appropriate memory address 35a that the micro-process 17 reads. Contained in the memory address 35a are winning indicia 36 and prize amounts, e.g., in binary format. The micro-processor 17 “reads” the contents of the winning indicia 36 of the indicated memory address 35a, decoding the contents of the winning indicia 36 accordingly, then, the micro-processor 17 “writes” the contents (i) to the printing device 19 where the prize, if any, is displayed in a human readable format, e.g., printed out on a sales receipt, and/or (ii) to a visual display unit 34 where the prize is displayed visually in a human readable format, e.g., using light emitting diodes. Furthermore, winning indicia 36 are coded so as to cause the micro-processor 17 to fetch and run a micro-program that, e.g., recalculates the final purchase amount of the sales transaction, taking into account the one or more prize amounts.

For example, if a certain machine readable data code 35 includes a memory address 35a and that memory address 35a contains a binary-coded message that indicates “$5 off your bill”, a message appears on the visual display unit 34 and/or is printed out on the sales receipt. Furthermore, $5 is subtracted automatically from the participant's purchase sub-total. As machine readable data codes 35 are read immediately after and/or as a final step of each sales transaction, verification is coincident with the winning determination.

This embodied instant lottery-type promotional game may also include a word, words or a phrase 42 that are substantially related to the sales transaction instead of or in combination with the machine readable data code 35. For example, the word, words or phrase 42 may provide for one or more of the following prizes: discount the total amount of the customer's current sales receipt, e.g., take off a specified percentage or dollar amount from the customer's sales receipt; provide a discount coupon for a specified percentage or dollar amount off of the customer's next purchase; and/or completely cover the total amount of purchase.

For example, the embodied word, words or phrase 42 may include “Receive $5 off of your total bill”, “Receive 10 percent off of your next purchase”, “Free Groceries”, and the like. Thus, once a customer has completed his or her purchase and has received his or her promotional game tickets 10, sales personnel visually inspect the playing game pieces 18 for winning indicia 36. If the promotional game ticket 10 is determined to be a winning game ticket, sales personnel may credit the customer's sales receipt in accordance with any prize amounts. With this embodiment, the determination and verification steps occur virtually simultaneously as the word, words or phrase 42 is its own verification code.

A variation, or second and third embodiment, of the above described instant lottery-type promotional games includes games offering prizes that are substantially unrelated to the customer's purchase, e.g., a specified prize, e.g., a new car or free trip, or mystery prize or amount of cash, and, moreover, do not affect the sales transaction. According to this second and third embodiment, the mechanisms for determining whether a promotional game ticket 10 is a winning game ticket include (i) using an interactive, online, e.g., Internet, Web site; (ii) using an interactive, e.g., toll free, telephone site; (iii) referring to a publication, e.g., on a poster, on an information board or in a periodical, disposed locally or remotely from the commercial establishment; and/or (iv) a word, words, phrase and/or symbols describing the prize won. See FIG. 4b and 4c.

Winning game pieces for the second and third embodied games maybe contained in, e.g., a list or a database 30, which customers holding promotional game tickets 10 are told how to access. For example, customers playing the second embodied game maybe told to access an online, e.g., Internet, Web site using, e.g., a uniform resource locator (“URL”) address that is provided in the instructions 24 on the promotional game ticket 10. The Web site contains a list of all winning game pieces for each ticket batch so customers may scan the list visually or, alternately, input their playing game piece 18 in compliance with an appropriate prompt to determine whether they have won any prize. Alternately, customers holding game tickets 10 may be told to dial an interactive, e.g., toll-free, telephone number, which then prompts customers to provide their playing game pieces 18, e.g., using the dialing keypad or voice activation. A remote server compares the customer's playing game pieces 18 with the list of winning game pieces, e.g., that are stored in database 30 connected to the remote server, and winning or not winning are announced audibly over the telephone. As another alternate, customers holding promotional game tickets 10 may be told to compare their playing game pieces 18 to winning game pieces 18 that are published, e.g., on an information board or a poster that is located in the commercial establishment, or in a dated periodical. The poster, information board, and/or periodical contain a list of all winning game pieces for a particular ticket batch, so customers may scan the list visually to determine whether they have won a prize.

If a customer believes that he or she has won a prize, he or she is instructed, e.g., by a message on the Web site, by a voice on the interactive telephone number, and/or by a message on the poster, information board, and/or periodical, to return the game ticket 10 to the place of issuance or an affiliated commercial establishment for authentication and verification. Verification and authentication may include a visual inspection of the card to ensure that it is genuine and has not been tampered with or otherwise altered and comparison of the security code 20, which is disposed on the face of each game ticket 10, with one or more winning security codes that are stored in database 30. If the customer's security code 20 matches one of the winning security codes contained in the database 30, then the customer may win the prize associated with that security code 20. As described above, the security code 20 corresponds to the unique memory address 35a in memory that contains the prize amount.

A fourth example embodiment of an instant lottery-type promotional game includes an array 29, or matrix, comprising more than one playing game pieces 18, e.g., a three by three matrix. See FIG. 4d. The playing game pieces 18 may comprise various cash amounts. According to this fourth example embodiment, winning game tickets comprise those promotional game tickets 10 that include multiple-occurring game pieces 18 within the array 29. For example, if three of the playing game pieces 18 in a single array 29 match, then the promotional game ticket 10 is a winning game ticket. Alternately, one or more of the playing game pieces 18 in the array 29 may include a wild card or, alternately, include a reference to, e.g., an information board or poster in the commercial establishment, a dated periodical, etc., wherein or whereon a universal playing game piece is disposed that participants may combine with any two matching playing game pieces 18 appearing on the promotional game ticket 10 to win.

If a customer believes that he or she has won a prize, he or she is instructed, e.g., by a message on the poster, information board, and/or an affiliated commercial establishment for authentication and verification. Verification and authentication may include a visual inspection of the card to ensure that it is genuine and has not been tampered with or otherwise altered and comparison of the security code 20, which is disposed on the face of each game ticket 10, with one or more winning security codes 20 that are stored in a database 30. If the customer's security code 20 matches one of the winning security codes contained in the database 30, then the customer may win the prize associated with that security code 20.

Example embodiments of the present invention may be practiced equally as well using draw-type promotional games. FIG. 4e illustrates a fifth illustrative game according to one example embodiment of the present invention. As before, it should be obvious to those skilled in the art that other embodiments to and/or modifications, combinations, and substitutions of the present invention are possible, all of which are within the scope and spirit of the disclosed invention.

In this fifth illustrative game, a plurality of playing game pieces 18 are disposed in a matrix or array 29, e.g., a four by four matrix. The playing game pieces 18 may be Arabic numerals. Alternately, one or more of the playing game pieces 18 may include a free space. This embodied game is played in conjunction with a schedule drawing event much like the game of bingo. Indeed, the object of the game is to match one's playing game pieces 18 against winning game pieces that are randomly drawn during a scheduled drawing event. Alternately, the winning game pieces may be published, e.g., on a Web site, telephone message, information board, poster, and/or dated periodical.

A winning game ticket includes a game ticket 10 in which the winning game pieces 18 match all of a participant's playing game pieces 18 in one or more rows R, columns C or diagonals D. Moreover, the more rows R, columns C, and/or diagonals D that are matched completely, the greater the prize.

If a customer believes that he or she has won a prize, he or she is instructed, e.g., by instructions 24 on the promotional game ticket 10 or by a message provided during the scheduled drawing event, to return the winning game ticket 10 to the place of issuance or an affiliated commercial establishment for authentication and verification. Verification and authentication include a visual inspection of the card to ensure that it is genuine and has not been tampered with or otherwise altered and comparison of the security code 20, which is disposed on the face of the game ticket 10, with one or more winning security codes 20 that are stored in a database 30. If the customer's security code 20 matches one of the winning security codes contained in the database 30, then the customer may win the prize associated with that security code 20.

A sixth example according to the present invention comprises an interactive, online game that participants may play, e.g., an Internet spot the ball game such as the game disclosed in U.S. application Ser. No. 09/575,501 filed May 19, 2000, which is incorporated herein by reference. The promotional game ticket 10 may include an Internet URL address 22 and an access code 21.

To play, participants may log on to the indicated URL address 22 using the access code 21, which access code 21 is good for one playing event. Then, participants play the interactive game in accordance with the rules and regulations of play. If a participant wins the game, he or she is prompted to provide personal information, e.g., his or her name, address, telephone number, etc. This personal information is stored in database 30 at memory address 35a that is identified with his or her access code 21 for use in authentication and verification.

The participant then is instructed to return the winning game ticket 10 to the place of issuance or an affiliated commercial establishment for authentication and verification. Verification and authentication include a visual inspection of the card to ensure that it is genuine and has not been tampered with or otherwise altered and comparison of the access code 21 with the input personal information and access code 21 that are stored in database 30. If the participant's access code 21 matches one of the winning access codes contained in database 30 and the customer provides proper identification that corresponds to the personal information that was stored in database 30, then the customer may win the prize associated with that access code 21.

A seventh example promotional game is played in accordance with the “Pick Four” draw-type game format, except participants do not get to pick their own, e.g., four, playing game pieces 18. The playing game pieces 18 in this instance are pre-printed as part of the promotional game ticket 10 on the reverse side 16 of the till roll 12.

This embodied game may be played in conjunction with a scheduled drawing event. Indeed, the object of the game is to match one's playing game pieces 18 and the sequence in which they occur against winning game pieces that, e.g., maybe randomly drawn during a scheduled drawing event and their sequence. Alternately, the winning game pieces and their sequence may be published, e.g., on a Web site, on a telephone message, information board, poster, and/or dated periodical.

A winning game ticket includes a game ticket 10 in which the winning game pieces match all of a participant's playing game pieces 18 in the proper sequence. If a customer believes that he or she has won a prize, he or she is instructed, e.g., by instructions 24 disposed on the promotional game ticket 10 or by a message provided during the scheduled drawing event, to return the winning game ticket 10 to the place of issuance or an affiliated commercial establishment for authentication and verification. Verification and authentication may include a visual inspection of the card to ensure that it is genuine and has not been tampered with or otherwise altered and comparison of the security code 20, which is disposed on the face of the game ticket 10, with one or more winning security codes that are stored in database 30. If the customer's security code 20 matches one of the winning security codes contained in database 30, then the customer may win the prize associated with that security code 20.

In a separate embodiment of the above-described draw-type game, participants may draw winning game pieces themselves, e.g., from a container or drum that contains each of the playing game pieces 18.

While a number of embodiments of the invention have been described, it should be obvious to those skilled in the art that other embodiments to and/or modifications, combinations, and substitutions of the present invention are possible, all of which are within the scope and spirit of the disclosed invention.

For instance, promotional game tickets 10 do not have to be pre-printed continuously on the reverse side 16 of the till roll 12. Indeed, in another embodiment, only a single promotional game ticket 10 may be disposed on the till roll 12 and the customer who receives that single ticket receives a prize. Alternately, promotional game tickets 10 may be spaced intermittently, e.g., randomly or equidistant, so that not every customer, necessarily, is awarded a promotional game ticket 10.

Additionally, although in the preferred embodiment of draw-type games, winning game pieces were randomly selected during scheduled drawing events, the “drawing event” does not have to be scheduled or embody a drawing. Rather, the event may include any naturally or artificially occurring event, the outcome of which may be represented by a playing game piece 18. For example, the event may include scores of or number of paid admissions to a sporting event or the closing ticker value of a stock market index, etc. Those skilled in the art will appreciate the boundless number and type of events that may be used to play a game according to the present intention.

Moreover, although the games described herein have been described as promotional games, it is within the scope and spirit of the disclosed to include non-promotional games, e.g., state or national lotteries, for which till rolls 12 are used to distribute the playing game tickets 10.

In the preceding specification, the present invention has been described with reference to specific example embodiments thereof It will, however, be evident that various modifications and changes may be made thereunto without departing from the broader spirit and scope of the present invention as set forth in the claims that follow. The specification and drawings are accordingly to be regarded in an illustrative rather than restrictive sense.

1-25. (Canceled).

26. A method of facilitating the play of a game of chance, comprising:
providing a participant with a playing game substrate, the playing game substrate including a plurality of game pieces disposed on a reverse side of a cash register till roll;
determining whether the playing game substrate is a winning game substrate; and
verifying that the playing game substrate is the winning game substrate, when the playing game substrate is presented for redemption.

27. The method of claim 26, further comprising:
conducting a sales transaction;
producing a sales receipt for the sales transaction, the sales receipt being disposed on an obverse side of the cash register till roll; and
providing the sales receipt to the participant.

28. The method of claim 26, further comprising:
publishing the winning game piece.

29. The method of claim 28, wherein the published winning game piece is compared with the plurality of playing game pieces in determining whether the plurality of playing game pieces is the winning game piece.

30. The method of claim 28, wherein the winning game piece is published in a random drawing event.

31. The method of claim 28, wherein the winning game piece is published in a scheduled drawing event.

32. The method of claim 28, wherein the winning game piece is published in results of one or more athletic events.

33. The method of claim 28, wherein the winning game piece is published in results of a stock market trading on a particular date.

34. The method of claim 28, wherein the winning game piece is published in an information board.

35. The method of claim 28, wherein the winning game piece is published in a poster.

36. The method of claim 28, wherein the winning game piece is published in a Web site.

37. The method of claim 28, wherein the winning game piece is published in a dated periodical.

38. The method of claim 28, wherein the winning game piece is published in an interactive telephone network.

39. The method of claim 26, wherein verifying the playing game substrate includes comparing a security code disposed on the playing game substrate with a plurality of winning security codes stored in a database.

40. The method of claim 26, wherein verifying the playing game substrate includes visually inspecting the playing game substrate for authenticity.

41. The method of claim 26, wherein determining whether the playing game substrate is the winning game substrate includes comparing a machine readable data code on the playing game substrate with a plurality of winning data codes.

42. A system for facilitating the play of a game of chance, comprising:
a playing game substrate disposed on a reverse side of a cash register till roll;
a distributing device distributing the playing game substrate; and
a verifying device verifying whether the playing game substrate is a winning game substrate.

43. The system of claim 42 further comprising:
a determining device determining whether the playing game substrate is the winning game substrate.

44. The system of claim 43, wherein the playing game substrate includes draw-type lottery tickets .

45. The system of claim 42, wherein the playing game substrate further includes instant lottery-type tickets.

46. The system of claim 42, wherein the playing game substrate further includes an interactive, online game.

47. The system of claim 42, wherein the playing game substrate further includes a plurality of playing game pieces.

48. The system of claim 42, wherein the playing game substrate further includes a security code corresponding to an address in a database accessible by a micro-processor, the address containing indicia of winning a prize for the purpose of determining whether the playing game substrate is the winning game substrate.

49. The system of claim 42, wherein the playing game substrate includes instructions for playing the game.

50. The system of claim 42, wherein the playing game substrate further includes an access code configured to enable playing a downloadable, interactive game located at the Web site address.

51. The system of claim 42, wherein the playing game substrate further includes a Web site uniform resource locator address.

52. The system of claim 42, wherein the verifying device further includes a data code reading device capable of reading a machine readable data code included on the playing game substrate.

53. The system of claim 52, wherein the data code reading device is a barcode scanner.

54. The system of claim 42, wherein the verifying device is configured to compare a security code disposed on the playing game substrate with a plurality of winning security codes stored in a database.

55. The system of claim 42, wherein the verifying device further includes a device configured to inspect the playing game substrate for a visual indicia of authenticity.

56. The system of claim 42, wherein the determining device is configured to compare a machine readable data code disposed on the playing game piece with a plurality of winning data codes.

57. A method of playing a game of chance comprising:
performing a sales transaction;
receiving a sales receipt produced from the sales transaction, the sales receipt having an obverse side and a reverse side, the obverse side having information about the sales transaction and the reverse side having a game ticket;
determining whether the game ticket is a winning game ticket; and
redeeming the ticket for a prize if the game ticket is a winning game ticket.

58. A game ticket for facilitating the play of a game of chance, comprising:
an obverse side having information of a sales transaction; and
a reverse side having a plurality of playing game pieces.

59. The game ticket of claim 58, further comprising:
a machine readable data code.

60. The game ticket of claim 58, further comprising:
a security code corresponding to an address in a database accessible by a micro-processor, the address containing indicia of winning a prize for the purpose of determining whether the game ticket is a winning game ticket.

61. The game ticket of claim 58, wherein the game ticket further includes an access code configured to enable playing a downloadable, interactive game located at a Web site address.

62. The game ticket of claim 58, wherein the game ticket further includes instructions for playing the game of chance.

63. The game ticket of claim 58, wherein the game ticket further includes a Web site uniform resource locator address.

64. A cash register till roll, comprising:
an obverse side;
a reverse side; and
a playing game substrate on the reverse side, the playing game substrate having a plurality of game pieces disposed thereon, the plurality of game pieces determining the outcome of a game of chance when compared to a plurality of winning game pieces.

65. The system of claim 64, further comprising an instant lottery-type game.

66. The system of claim 64, further comprising a draw-type lottery game.

67. The system of claim 64, further comprising an interactive, online game.

68. The system of claim 64, wherein the plurality of winning game pieces is randomly drawn during a drawing event.

69. The system of claim 64, wherein the plurality of winning game pieces is printed in a dated periodical.

70. The system of claim 64, wherein the plurality of winning game pieces is printed on a poster.

71. The system of claim 64, wherein the plurality of winning game pieces is posted on an information board.

72. The system of claim 64, wherein the plurality of winning game pieces is published audibly on an interactive telephone network.

73. The system of claim 64, wherein the plurality of winning game pieces is published downloadably on an interactive, online Web site.

74. An article of manufacture comprising a computer-readable medium having stored thereon instructions adapted to be executed by a processor, the instructions which, when executed, define a series of steps to be used to control a method for facilitating the play of a lottery game, the method comprising:
conducting a sales transaction;
producing a sales receipt for the sales transaction, the sales receipt being disposed on an obverse side of a cash register till roll;
providing the sales receipt to a participant;
providing a participant with a playing game substrate, the playing game substrate including a plurality of game pieces disposed on a reverse side of the cash register till roll;
determining whether the playing game substrate is a winning game substrate; and
verifying that the playing game substrate is the winning game substrate, when the playing game substrate is presented for redemption.
